(19) United States
(12) Patent Application Publication
(10) Pub. No.: US 2013/0083646 A1
(43) Pub. Date: Apr. 4, 2013

(54) Methods and Apparatus for Managing Resource Access Attempts

(71) Applicants: Hannu Hietalahti, Kiviniemi (FI); Steven FRANKLIN, Guildford (GB); Keiichi KUBOTA, Weybridge (GB)

(72) Inventors: Hannu Hietalahti, Kiviniemi (FI); Steven FRANKLIN, Guildford (GB); Keiichi KUBOTA, Weybridge (GB)

(73) Assignee: Renesas Mobile Corporation

(21) Appl. No.: 13/249,415

(22) Filed: Sep. 30, 2011

(51) Int. Cl. H04W 48/02

(52) U.S. Cl. 370/216

(57) ABSTRACT

Systems and techniques for management of network resource access attempts. In response to identifying that a radio bearer has failed, a radio resource associated with the radio bearer is released, either through request by a user equipment or direction by the network. Attempts at regaining access to the released radio bearer are inhibited during conditions recognized as potentially leading to excessively frequent unsuccessful attempts. Inhibition of attempts at regaining access to the released radio bearer may comprise imposing a backoff timer to inhibit reestablishing access to the released radio link for the duration specified by the backoff timer.

### FIELD OF THE INVENTION

The present invention relates generally to wireless communication. More particularly, the invention relates to improved systems and techniques for controlling access attempts by a device to a network resource.

### BACKGROUND OF THE INVENTION

The following abbreviations that may be found in the specification and/or the drawing figures are defined as follows:
3 GPP Third Generation Partnership Project
APN access point name
eNB evolved Node B
e-UTRAN evolved UTRAN
IE information element
LTE long term evolution
NAS non-access stratum
PDP packet data protocol
RAB radio access bearer
RRC radio resource control
UE user equipment
UTRAN universal terrestrial radio access network

Interest in wireless communication, particularly personal wireless communication, has increased more and more during the last few decades, and user demand for the ability to transmit and receive information wirelessly has proven insatiable. More and more users wish to spend more and more of their time communicating with one another, sharing data with others, and receiving data made available to the public at large or to large groups of users, so that serving the simultaneous activities of these users while providing an acceptable quality of service to each user has proven more and more challenging. One problem that can lead to inefficiency is the occurrence of errors and the reaction to errors. Errors may involve or cause loss of connection and may lead to reconnection attempts. If not properly managed, these reconnection attempts may lead to an excessive signaling burden, because of the possibility of repeated unsuccessful reconnection attempts.

### SUMMARY OF THE INVENTION

In one embodiment of the invention, an apparatus comprises a computer readable memory and at least one processor. The apparatus further comprises a program of instructions configured to, with the computer readable memory and the processor, cause the apparatus to perform actions comprising identifying that an active radio bearer has failed, releasing a radio resource associated with the failed radio bearer, and inhibiting reestablishing access to the released radio resource during conditions recognized as potentially leading to excessively frequent unsuccessful attempts.

In another embodiment of the invention, a method comprises, upon identifying that an active radio bearer has failed, causing release by a user equipment of a radio resource associated with the failed radio bearer and inhibiting reestablishing access to the released radio resource during conditions recognized as potentially leading to excessively frequent unsuccessful attempts.

In another embodiment of the invention, a non-transitory computer readable medium stores a program of instruction, execution of which by a processor causes an apparatus to perform functions comprising, upon identifying that an active radio bearer has failed, causing release by a user equipment of a radio resource associated with the failed radio bearer and inhibiting reestablishing access to the released radio resource during conditions recognized as potentially leading to excessively frequent unsuccessful attempts.

These and other embodiments and aspects are detailed below with particularity.

### BRIEF DESCRIPTION OF THE DRAWINGS

FIG. 1 illustrates an exemplary network according to an embodiment of the present invention;

FIGS. 2-4 illustrate signaling between network elements according to an embodiment of the present invention;

FIGS. 5A-5C illustrate details of network components according to an embodiment of the present invention; and

FIG. 6 illustrates a process according to an embodiment of the present invention.

### DETAILED DESCRIPTION OF THE PREFERRED EMBODIMENTS

Systems and techniques according to various embodiments of the present invention recognize that users frequently wish to use voice and data services simultaneously, and that errors affecting the use of one type of service may, unless properly managed, cause disruptions to the other type of service. For example, voice services are frequently implemented as circuit switched (CS) voice calls and data services are frequently implemented as packet switched (PS) data calls. A wireless connection may thus simultaneously be involved in different types of communication using different radio bearers, and it may happen that a radio bearer on which one type of communication depends is disrupted, while another radio bearer on which another type of communication depends is unaffected. For example, a user equipment (UE) engaged in a packet switched data call may experience failure of the call due to detection of a radio link control (RLC) unrecoverable error on a PS radio bearer in the weak field.

Current third generation partnership project (3 GPP) standards mandate that a UE initiate a cell update procedure when a UE detects an RLC unrecoverable error, and any service is temporarily disrupted during the cell update procedure, or the service is dropped if the service domain does not support a call reestablishment procedure. If a UE is engaged in one service that is disrupted by an RLC error, the requirement to perform a cell update procedure may cause general disruptions of all services. For example, as specified by 3 GPP TS 36.331, 5.3.11, a UE is to release a radio resource control (RRC) connection, or initiate an RRC connection re-establishment procedure. Therefore, radio link failure (RLF) detection on one radio bearer may affect a service using another radio bearer.

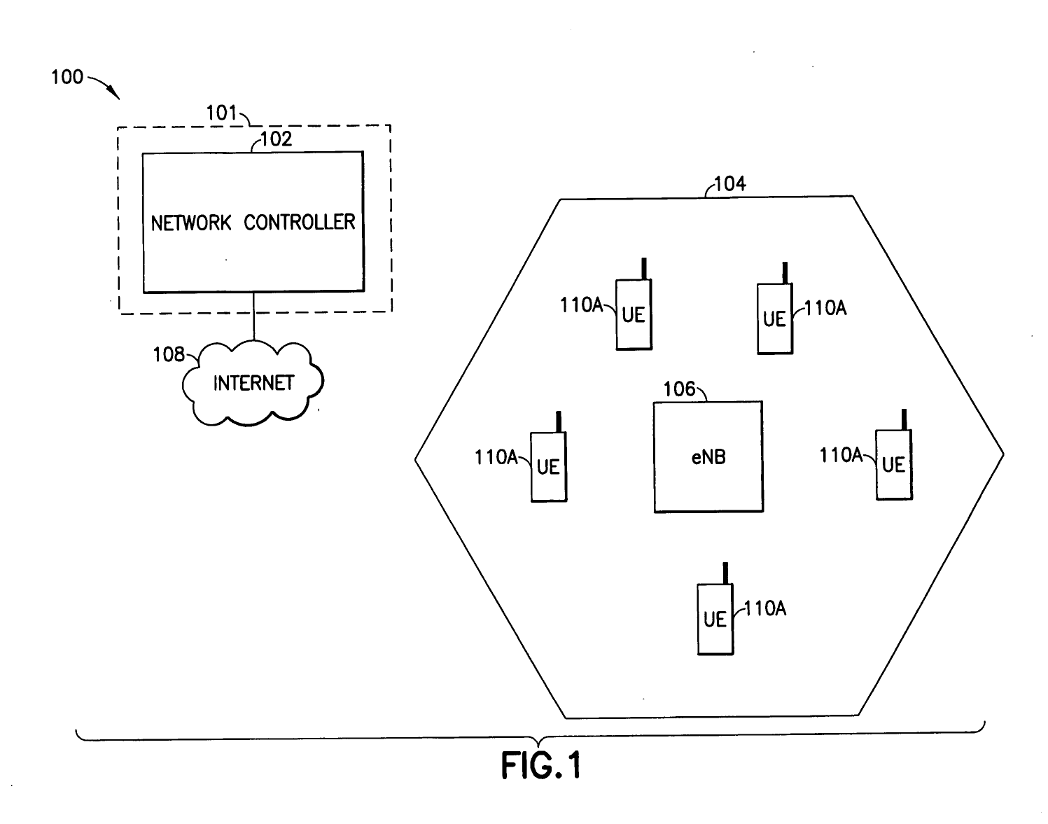

FIG. 1 illustrates a network 100 according to an embodiment of the present invention. The network 100 comprises a core network 101, suitably comprising a network 102 configured to manage network operations. The network controller 102 suitably provides services to a number of cells of which an exemplary cell 104 is shown here. The cell 104 may be thought of as a geographic region in the vicinity of a base station 106, connected to and receiving services from the network controller 102. The core network 101 may suitably provide access to the public Internet 108 through an appropriate connection, providing Internet access to users through base stations such as the base station 106. The base station 104 may suitably be implemented as an evolved node B (eNB).

The base station 106 may provide services to a plurality of UEs 110A-110E, which may communicate with the base station using appropriate radio bearers. The base station 106 may provide such services as are needed to allow the UEs 110A-110E to communicate with one another or with other devices as needed.

According to various embodiments of the invention, a release of a network resource such as a PDP context or a radio bearer results in assignment of a backoff timer to the UE. In one embodiment, the UE requests the network to release a radio access bearer (RAB) when an RLC unrecoverable error is detected on the RAB. Suitably, the release request may indicate that the release, or deactivation, was triggered due to an access stratum (AS) error, and the network may respond to the release request by providing a backoff timer to inhibit attempts at regaining access to the released RAB for the duration specified by the backoff timer.

However, in some circumstances, additional information may be available that allows for resumption at regaining access to the RAB. For example, if regaining access to an RAB supporting a packet-switched resource is being inhibited in order to avoid disrupting an in-process circuit-switched call, attempts at access may be resumed if the call ends, even if the backoff timer has not yet expired. Additional information may also be available that may indicate that attempts at regaining access to an RAB may be resumed before expiration of the backoff timer. For example, if connectivity improves such that it may be expected that access can be regained without excessive risk of failed attempts, attempts at regaining access may be resumed before expiration of the backoff timer. In addition, significant information may be available about the ability of a device to connect in an efficient way, even without direct information relating to connectivity. Many devices, for example, are able to obtain and report information about their geographic location. Knowledge of the geographic location of a device, or an inability of the device to report its location may indicate whether the device can be expected to experience good connectivity. For example, a device may be in a building or underground and unable to report its location. From this fact, it may be surmised that the device is experiencing poor connectivity and that attempts at regaining access to a released RAB should be inhibited. Depending on network design and configuration, such management of access attempts may be performed in addition to, or as an alternative to, use of the backoff timer.

In various embodiments of the invention, the network provides a backoff timer to a UE during a signaling connection establishment for the associated core network domain, a radio access bearer establishment procedure, or the RAB release procedure. If a backoff timer is provided to the UE by the network, the UE starts the backoff timer. A packet data protocol (PDP) activation procedure that would otherwise be performed is inhibited until expiration of the backoff timer.

In various embodiments of the invention, the backoff timer may inhibit any PDP context activation, or may inhibit a PDP context activation toward one or more specified properties. For example, inhibition of the PDP context may be configured so that inhibition of context activation is directed only to the same PDP address or the same access point name (APN) as was used for the released RAB. Such direction toward specific properties may be accomplished by configuring a backoff timer identified with each PDP address or access point name (APN), with an appropriately configured backoff timer being delivered depending on the specific PDP address or APN for which context activation is to be inhibited.

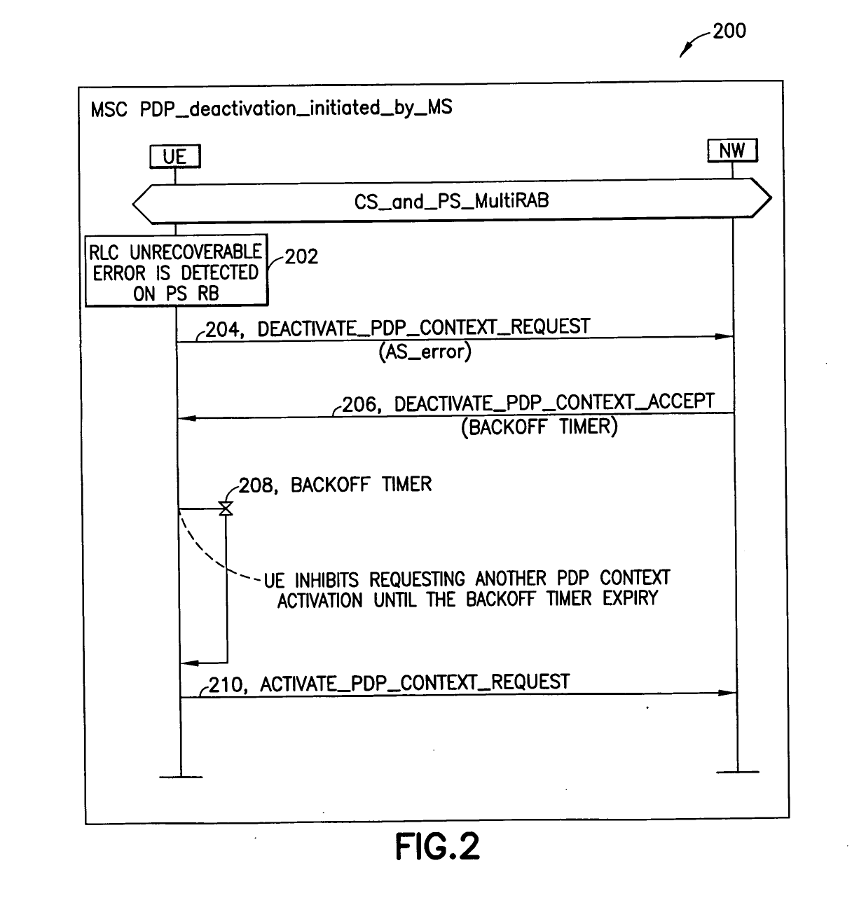

As a further alternative, the network may configure and deliver a backoff timer with applicability information that may specify “PDP address,” “APN,” “PDP address and APN,” or “any”. As a further alternative, a backoff timer may be configured to inhibit a service request procedure toward the PDP context associated with the released RAB. Details of various specific embodiments are presented below in connection with FIGS. 2-5.

FIG. 2 illustrates a diagram 200 showing the exchange of signals occurring as a result of PDP context deactivation by a user equipment (UE). Upon detection of an RLC unrecoverable error 202, the UE reports the error to the network. Detection of the error may occur, for example, on the packet switched radio bearer (PS RB). Reporting of the error may suitably be accomplished through signaling from the access stratum (AS) layer at the UE to the non-access stratum (NAS) entity at the corresponding domain of the core network. The UE NAS entity initiates a PDP context deactivation procedure for the radio access bearer where the RLC unrecoverable error was detected. The initiation may be accomplished by sending a DEACTIVATE PDP CONTEXT REQUEST message 204 with an information element that indicates that the deactivation was made due to an AS error. The network replies with a DEACTIVATE PDP CONTEXT ACCEPT 206 message with an information element that indicates a backoff timer 208. The information element may suitably include information configuring the backoff timer 208, for example, setting a duration for the backoff timer 208. In embodiments of the invention, the specific entities to which the backoff timer applies may be also be identified in the information element. The identification may specify entities such as “APN,” “PDP address,” PDP address and APN,” and “any”. In this way, only the specified entity is subject to inhibition of context activation. At deactivation of the PDP context, the UE starts the backoff timer 208, inhibiting PDP context activation until the expiration of the backoff timer. Activation, when allowed, may take the form of a PDP context activation request 210. If a specific entity was identified with the backoff timer, only the specified entity will be subject to inhibition of activation.

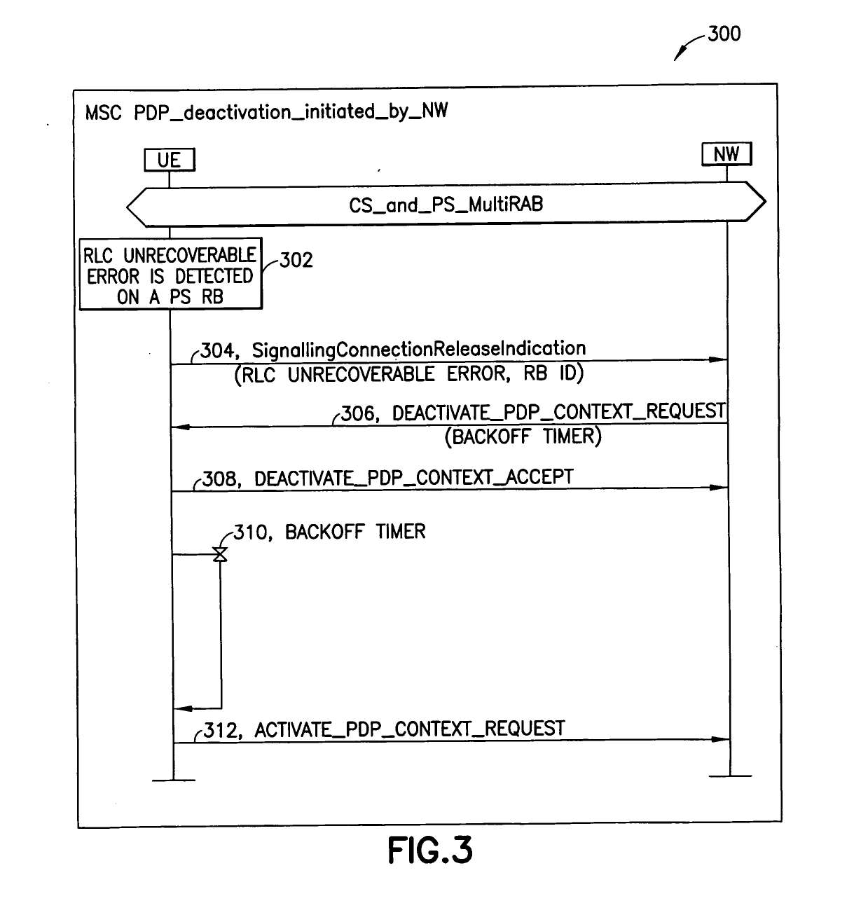

FIG. 3 illustrates a signaling diagram 300, showing signals exchanged in another embodiment of the invention, involving initiation of PDP context deactivation by the network. In this embodiment, upon detection of an RLC unrecoverable error 302, a UE radio resource control may send an uplink RRC message 304, such as a signaling connection release indication message, to report an RLC unrecoverable error to the network when the error is detected. In another embodiment of the invention, the network itself may detect the RLC unrecoverable error. In response to the report or detection of the RLC unrecoverable error, the network initiates a PDP context deactivation procedure toward the PDP context in which the RLC unrecoverable error occurred, sending a DEACTIVATE PDP CONTEXT REQUEST message 306. The message includes a backoff timer information element, which may include configuration information such as a timer duration and specification of the entity to which the request applies, such as “APN,” “PDP address,” “PDP address and APN,” or “any”. The UE responds by deactivating the PDP context and replies with a DEACTIVATE PDP CONTEXT ACCEPT message 308. The UE starts the backoff timer 310 and inhibits any PDP context activation during the duration of the backoff timer. Again, inhibition of context activation is directed toward the entity indicated by the backoff timer, if the backoff timer includes such information. Activation, when allowed, may take the form of an ACTIVATE PDP CONTEXT REQUEST message 312.

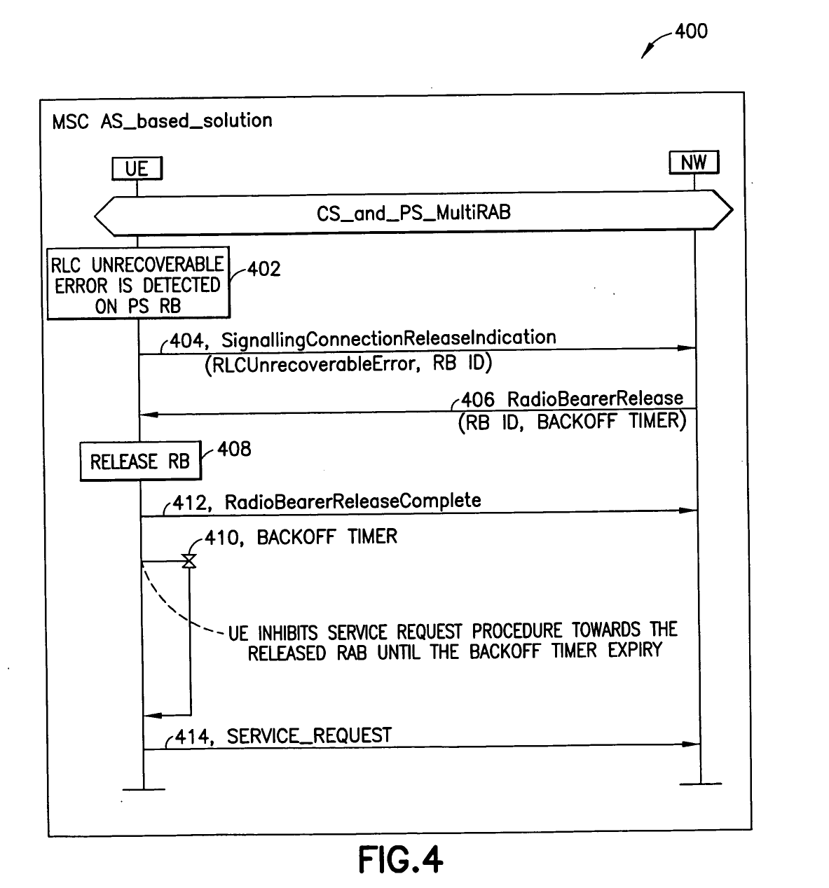

FIG. 4 illustrates a signaling diagram 400, showing exchange of signals in another embodiment of the invention, involving release of a radio access bearer. In this embodiment, upon the detection of an RLC unrecoverable error 402, the UE RRC may send an uplink RRC message, such as a signaling connection release indication message 404, to report an RLC unrecoverable error to the network upon detection. Alternatively, the network may detect the RLC unrecoverable error. In response to the report, or its own detection, of the error, the network releases a radio bearer for which the error was reported. This release may be accomplished by sending a RadioBearerRelease message 406, causing a release RB action 408.

The RadioBearerRelease message 406 suitably includes an information element including a backoff timer 410. The information element may suitably include timer duration. The UE RRC forwards the configuration of the backoff timer 410 to the UE NAS entity and the UE RRC releases the corresponding radio bearer and replies with a RadioBearerReleaseComplete message 412. The UE may suitably start the backoff timer 410 and inhibit a service request procedure toward a PDP context associated with the released radio access bearer until the backoff timer expiration. When allowed, the service request procedure may take the form of a SERVICE REQUEST message 414.

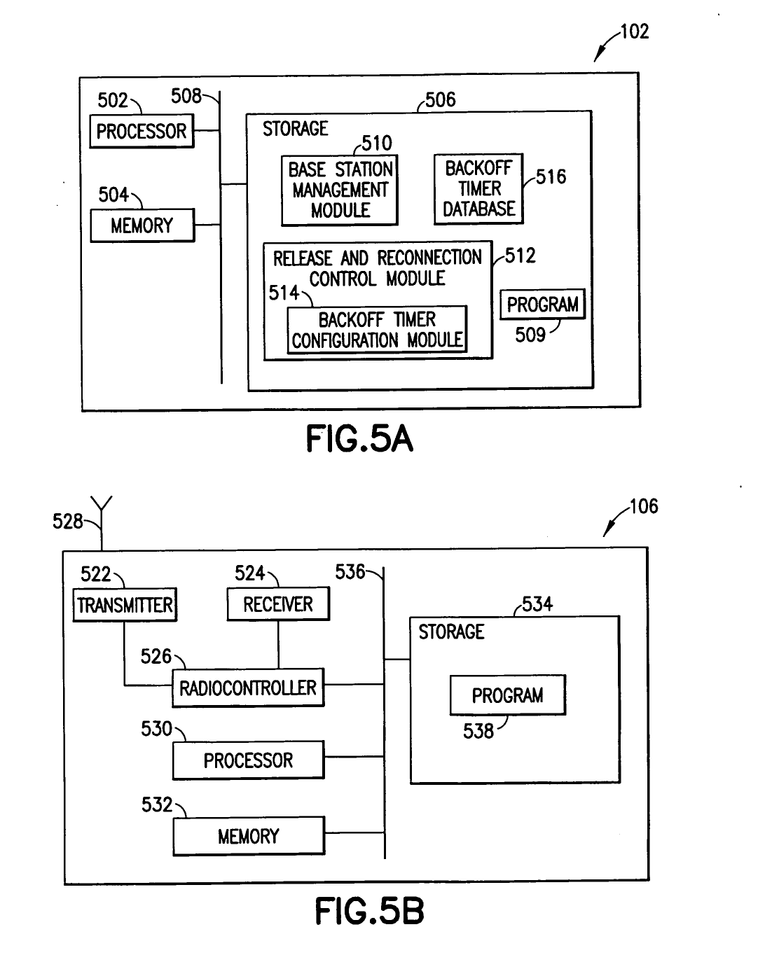

FIGS. 5A-5C illustrate additional details of the network controller 102, the base station 106, and the exemplary UE 110A, respectively. It will be recognized that the particular configurations shown here are exemplary only, and that significant variations between devices may exist that may employ embodiments of the present invention.

FIG. 5A illustrates the network controller 102, which may suitably communicate with base stations such as the base station 106 using mechanisms known in the art, and may employ a processor 502, memory 504, and storage 506, communicating over a bus 508. The network controller 102 may store a program of instructions 509, residing in storage 506 and transferred to memory 504 as needed for execution by the processor 502, in order to perform functions according to embodiments of the present invention. The network controller 102 may employ a base station management module 510 and a release and reconnection control module 512, suitably implemented as software residing in storage 506 and transferred to memory 504 as needed for execution by the processor 502. The release and reconnection control module 512 may include a backoff timer configuration module 514, which configures appropriate backoff timers for delivery to UEs, with the backoff timers suitably being configured and delivered as needed, or configured before an immediate need and stored, for example, in a backoff timer database 516.

FIG. 5B illustrates the base station 106, which may comprise a transmitter 522, receiver 524, radiocontroller 526, and antenna 528. The base station 106 may also comprise a processor 530, memory 532, and storage 534, communicating with one another and with the radiocontroller 526 over a bus 536. The network controller 102 may store a program of instructions 538, residing in storage 506 and transferred to memory 504 as needed for execution by the processor 502, in order to perform functions according to embodiments of the present invention.

FIG. 5C illustrates the UE 110A, which may comprise a transmitter 542, receiver 544, radiocontroller 546, and antenna 548. The UE 110A may also comprise a processor 550, memory 552, and storage 554, communicating with one another and with the radiocontroller 546 over a bus 556. The network controller 102 may store a program of instructions 557, residing in storage 506 and transferred to memory 504 as needed for execution by the processor 502, in order to perform functions according to embodiments of the present invention. The UE 110A may further comprise mechanisms for detecting and handling errors, such as an error detection and reporting module 558, and a release and reconnection module 560, suitably implemented as software residing in storage 554 and transferred to memory 552 as needed for execution by the processor 550. Upon detection of an error affecting a network resource, such as an unrecoverable RLC error, the UE 110A may report the error to the network controller 102, suitably by communicating a suitable message to the base station 106, which is in turn relayed by the base station 106 to the network controller 102. As discussed above, the network controller 102 may take appropriate steps in response to reporting of the error, such as releasing a radio bearer or connection, with the release suitably including or being accompanied by delivery of a backoff timer to the UE 110A. The release and reconnection module 560 then suitably controls the UE 110A so as to inhibit reconnection attempts as specified by the backoff timer.

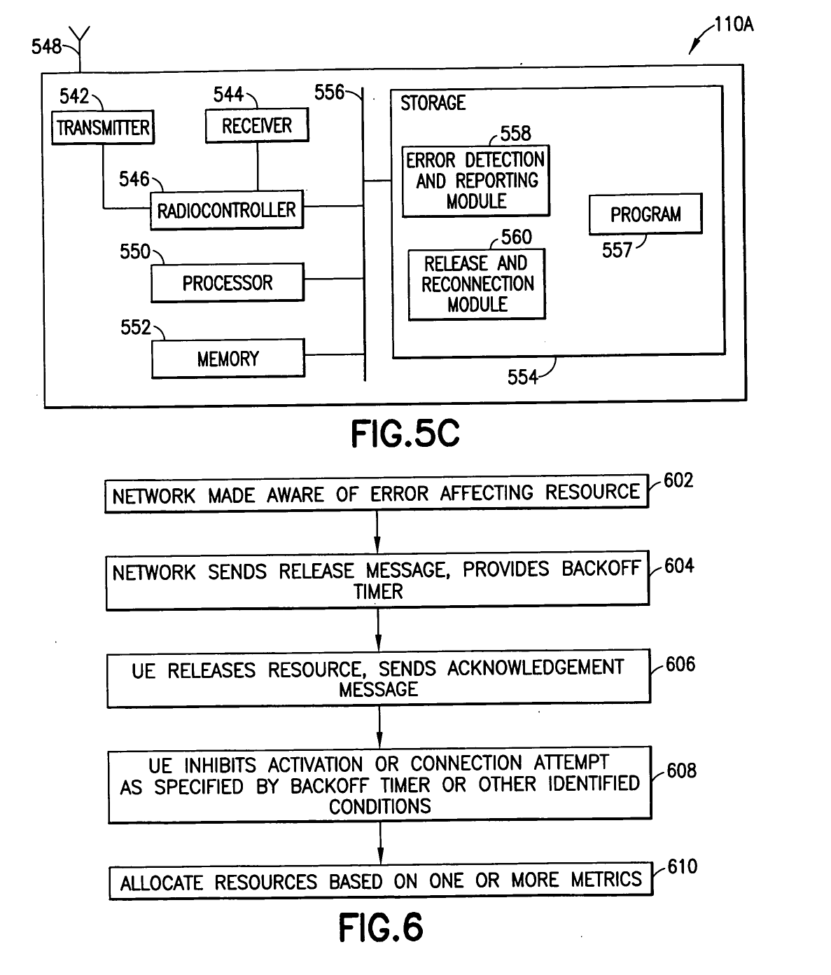

FIG. 6 illustrates a process 600 of error handling according to an embodiment of the present invention. At step 602, upon occurrence of an error affecting a network resource, such as a PDP context or radio bearer, and requiring release or disconnection of the resource, a network is made aware of the error. For example, the error may be reported by a UE or appropriate network elements, such as a network controller, may perform procedures to monitor network conditions and recognize errors. At step 604, upon recognition of the error by the network, a network element, such as a network controller, releases the affected resource. The release may be accomplished, for example, by directing an appropriate message to a UE, such as a DEACTIVATE PDP CONTEXT REQUEST message or a RadioBearerRelease message. The message that is directed to the UE may suitably include information defining a backoff timer, such as an information element specifying the entity to which the backoff timer applies and the backoff timer duration. The backoff timer may be configured to inhibit attempts at regaining the released resource. Alternatively or in addition, however, other mechanisms may be used to inhibit regaining of access to the resource. For example, attempts might be inhibited for the duration of a service, such as a circuit-switched call, that might be disrupted by access attempts, or attempts might be inhibited during poor connectivity or while a device is in a poor geographic location and resumed during good connectivity or while a device is in a good geographic location. These and similar mechanisms might also be used along with the backoff timer, so that when conditions allow for resumption of attempts to regain access, the attempts are resumed even before the backoff timer expires. At step 606, upon receiving the message releasing the resource, the UE performs and acknowledges the release. At step 608, inhibition of reconnection or activation attempts for the released resource is performed, for example, according to the directions specified by the backoff timer, which may include provisions that inhibition of attempts may cease before timer expiration if conditions warrant, or based on other information, such as the cessation of the conditions requiring inhibition or improved connectivity or geographic location.

While various specific embodiments of the invention are described above, it will be recognized that a wide variety of implementations may be employed by persons of ordinary skill in the art in accordance with the above description and the claims which follow below.

1. An apparatus comprising:
a computer readable memory;
at least one processor;
a program of instructions configured to, with the computer readable memory and the processor, cause the apparatus to perform actions comprising:
identifying that an active radio bearer has failed;
releasing a radio resource associated with the failed radio bearer; and
inhibiting reestablishing access to the released radio resource during conditions recognized as potentially leading to excessively frequent unsuccessful attempts.

2. The apparatus of claim 1, wherein reestablishing access to the released radio resource is inhibited for one or more specified entities.

3. The apparatus of claim 2, wherein inhibiting reestablishing access to the released radio resource comprises imposing a backoff timer to inhibit reestablishing access to the released radio resource for a duration specified by the backoff timer.

4. The apparatus of claim 2, wherein the released radio resource is a packet data protocol (PDP) context.

5. The apparatus of claim 2, wherein the released radio resource is a radio access bearer.

6. The apparatus of claim 3, wherein the backoff timer is imposed through a message including information identifying the backoff timer and wherein the information identifying the backoff timer is an information element in a deactivation accept message.

7. The apparatus of claim 2, wherein the apparatus is a user equipment, wherein the failure is caused by a radio link control unrecoverable error, and wherein the actions comprise reporting the error to a domain of a core network in which the user equipment is operating.

8. The apparatus of claim 2, wherein reporting the error is accomplished by signaling of an access stratum layer at the user equipment to a non-access stratum entity at the corresponding domain of the core network.

9. The apparatus of claim 3, wherein the information defining the backoff timer specifies a packet data protocol address.

10. The apparatus of claim 3, wherein the information defining the backoff timer specifies an access point name.

11. A method comprising:
upon identifying that an active radio bearer has failed:
causing release by a user equipment of a radio resource associated with the failed radio bearer; and
inhibiting reestablishing access to the released radio resource during conditions recognized as potentially leading to excessively frequent unsuccessful attempts.

12. The method of claim 11, wherein reestablishing access to the released radio resource is inhibited for one or more specified entities.

13. The method of claim 12, wherein inhibiting reestablishing access to the released radio resource comprises imposing a backoff timer to inhibit reestablishing access to the released radio resource for a duration specified by the backoff timer.

14. The method of claim 12, wherein identification of the failure comprises identification of an error causing the failure and further comprises reporting of the error by a user equipment to a core network.

15. The method of claim 12, wherein reporting of the error comprises signaling from an access stratum layer at the user equipment to a non-access stratum layer at the core network.

16. The method of claim 12, wherein identification of the error further comprises detection of the error by one or more of a radio network controller and an e-node B.

17. A non-transitory computer readable medium storing a program of instructions, execution of which by a processor causes an apparatus to perform functions comprising:
upon identifying that an active radio bearer has failed:
causing release by a user equipment of a radio resource associated with the failed radio bearer; and
inhibiting reestablishing access to the released radio resource during conditions recognized as potentially leading to excessively frequent unsuccessful attempts.

18. The computer readable medium of claim 17, wherein reestablishing access to the released radio resource is inhibited for one or more specified entities.

19. The computer readable medium of claim 18, wherein inhibiting reestablishing access to the released radio resource comprises imposing a backoff timer to inhibit reestablishing access to the released radio resource for a duration specified by the backoff timer.

20. The computer readable medium of claim 19, wherein imposing the backoff timer comprises including an information element defining the backoff timer in a deactivation request message.

21. The computer readable medium of claim 19, wherein the apparatus is a user equipment, wherein the failure is identified as being caused by a radio link control unrecoverable error, and wherein the functions comprise reporting the error to a domain of a core network in which the user equipment is operating and wherein reporting the error is accomplished by signaling of an access stratum layer at the user equipment to a non-access stratum entity at the corresponding domain of the core network.
